(19) United States
(12) Patent Application Publication
(10) Pub. No.: US 2014/0294045 A1
(43) Pub. Date: Oct. 2, 2014

(54) CAPACITOR MODULE AND DETECTION APPARATUS

(71) Applicant: Toyota Jidosha Kabushiki Kaisha, Toyota-shi Aichi-ken (JP)

(72) Inventor: Ryouji Hironaka, Gamagoori Aichi-ken (JP)

(73) Assignee: Toyota Jidosha Kabushiki Kaisha, Toyota-shi Aichi-ken (JP)

(21) Appl. No.: 14/231,909

(22) Filed: Apr. 1, 2014

(30) Foreign Application Priority Data
Apr. 2, 2013 (JP) 2013-077169

(51) Int. Cl. H01G 9/26; G01K 13/00

(52) U.S. Cl. CPC H01G 9/26; G01K 13/00
USPC 374/142; 361/434

(57) ABSTRACT

A capacitor module includes a plurality of capacitor elements, a bus bar, a contact portion, and a temperature sensor. The bus bar includes an element connection portion on one end thereof and an electrode portion for external connection on the other end thereof, the element connection portion being electrically connected to respective terminal portions of the plurality of capacitor elements. The contact portion is connected to the bus bar and makes contact with heat generation portions of the plurality of capacitor elements. The temperature sensor is disposed on a portion extending from the contact portion. A detection apparatus includes the capacitor module and a detecting circuit that includes a temperature detecting circuit connected to one and the other terminals of the temperature sensor, and a voltage detecting circuit connected to the other terminal of the temperature sensor and detecting a voltage between negative and positive terminals of the capacitor module.

### INCORPORATION BY REFERENCE

The disclosure of Japanese Patent Application No. 2013-077169 filed on Apr. 2, 2013 including the specification, drawings and abstract is incorporated herein by reference in its entirety.

### BACKGROUND OF THE INVENTION

1. Field of the Invention

The present invention relates to a capacitor module constituted by a plurality of capacitor elements, and a detection apparatus.

2. Description of Related Art

In order to smooth a current and a voltage, a capacitor module in which a plurality of capacitor elements is connected to each other is used. The capacitor element repeats discharge and charge to generate heat, so that its temperature is observed.

For example, Japanese Patent Application Publication No. 2009-111370 (JP 2009-111370 A) describes a case molded capacitor configured such that a plurality of capacitors is connected via a bus bar provided with a terminal portion for external connection and accommodated in a case, and resin molding is performed thereon except the terminal portion of the bus bar, and it is described that heat generation of the capacitors is detected by a thermistor. Herein, the thermistor is provided between the bus bar and the capacitors, between the capacitors adjacent to each other, or the like.

Further, Japanese Patent Application Publication No. 2008-148530 (JP 2008-148530 A) describes a capacitor module used for an inverter apparatus, and the capacitor module includes positive and negative connection conductors. In the connection conductors, the capacitors are connected in parallel to each other. A part of the connection conductors serves as a positive/negative terminal for the capacitors. Another part of the connection conductors serves as a heat conducting portion.

Japanese Patent Application Publication No. 2012-78328 (JP 2012-78328 A) describes that, in a case where a current flowing through a bus bar is detected from a resistance drop between an upstream and a downstream of the bus bar, a circuit substrate including a temperature detection diode is provided in the bus bar, so that an influence of a temperature is corrected. Herein, in order to reduce a difference in temperature between the bus bar and the temperature detector diode, a material having good thermal conductivity is sandwiched between the bus bar and the circuit substrate.

### SUMMARY OF THE INVENTION

Since a capacitor module is constituted by a plurality of capacitor elements, a heat generation state varies according to a variation of characteristics of the capacitor elements. Further, when the capacitor module is connected to a load drive circuit so as to smooth a current and a voltage thereof, a burdened state of a ripple current flowing through the capacitor elements changes complicatedly according to an operating state of the driving circuit. On that account, it is often difficult to predict which part of the plurality of capacitor elements constituting the capacitor module reaches a maximum temperature.

A conceivable method for securing a heat-resistance characteristic of a capacitor module is that capacitor elements are having a large capacity are used, but the capacitor module becomes large and a cost increases. It is also conceivable that a temperature of each capacitor element is observed, but many temperature detecting means (temperature sensors) are required and man-hours for their attachment are also increase.

The present invention provides a capacitor module and a detection apparatus each of which is able to accurately detect a temperature of a plurality of capacitor elements without increasing the number of temperature detecting means.

A first aspect of the present invention relates to a capacitor module. The capacitor module includes a plurality of capacitor elements, a bus bar, a contact portion, and a temperature sensor. The bus bar includes an element connection portion on one end of the bus bar and an electrode portion for external connection on the other end of the bus bar, the element connection portion being electrically connected to respective terminal portions of the plurality of capacitor elements. The contact portion is connected to the bus bar and makes contact with heat generation portions of the plurality of capacitor elements. The temperature sensor is disposed on an extending portion extending from the contact portion.

According to the above configuration, the temperature sensor is provided in the extending portion extending from the contact portion. This makes it possible to accurately detect a temperature of the plurality of capacitor elements without being directly affected by a change of a ripple current.

In the capacitor module, the extending portion may define a path different from a path where a current flows.

In the capacitor module, since the extending portion is provided in a portion defining a path different from a path where a current flows, it is possible to accurately detect a temperature of the plurality of capacitor elements without being directly affected by the change of the ripple current.

The capacitor module may have a gap between the extending portion and a path where a current flows in the bus bar.

Since the capacitor module has a gap between the extending portion and the path where a current flows in the bus bar, a temperature of the extending portion is not directly affected by the change of the ripple current.

In the capacitor module, the contact portion is placed between the capacitor elements adjacent to each other.

In the capacitor module, since the contact portion is placed between the capacitor elements adjacent to each other, the extending portion extending from the contact portion has a temperature that reflects the temperature of the capacitor elements.

The capacitor module may further include a case and a molding resin. The case may accommodate therein the plurality of capacitor elements connected via the bus bar. The molding resin may be disposed in the case so as to mold the plurality of capacitor elements. The temperature sensor may be exposed from the molding resin.

In the capacitor module, since the temperature sensor is provided to be exposed from the molding resin filled into the case so as to mold the plurality of capacitor elements, it is possible to detect a temperature of the capacitor elements without being affected by a temperature characteristic of the temperature sensor.

A second aspect of the present invention relates to a detecting apparatus. The detection apparatus includes the above capacitor module and a detecting circuit. The detecting circuit includes a temperature detecting circuit detecting a temperature, and a voltage detecting circuit detecting a voltage between a negative terminal of the capacitor module and a positive terminal of the capacitor module. The temperature detecting circuit is electrically connected to one terminal and the other terminal of the temperature sensor. The voltage detecting circuit is electrically connected to the other terminal of the temperature sensor.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a view illustrating a structure of a capacitor module according to an embodiment of the present invention, FIG. 1A is a general view of the capacitor module, FIG. 1B is a view illustrating a connection state of a plurality of capacitor elements with respect to a bus bar, FIG. 1C is an expanded sectional view of a tip portion of a contact portion that is integrated with the bus bar and makes contact with the capacitor element, and FIG. 1D is a view illustrating the bus bar including the contact portion and an extending portion;

FIG. 2 is a view illustrating a reference example of the capacitor module;

FIG. 3 is a view illustrating another exemplary configuration different from FIG. 1;

FIG. 4 is a view illustrating another exemplary configuration different from FIG. 1,

FIG. 5 is a view illustrating another exemplary configuration different from FIGS. 1, 3, 4; and

FIG. 6 is a view illustrating a detecting circuit, etc., connected to the capacitor module according to the embodiment of the present invention and performing temperature detection and voltage detection.

### DETAILED DESCRIPTION OF EMBODIMENTS

The following describes an embodiment of the present invention in detail with reference to the drawings. The following description deals with a capacitor module connected to an inverter circuit to be provided in a hybrid vehicle or the like, but this is a description of one exemplary application, and the capacitor module may be a capacitor module used for other applications.

A material, a dimension, a shape, and a number to be described below are exemplifications for descriptions and can be changed appropriately according to specifications of the capacitor module. In the following description, corresponding elements in all the drawings have the same reference sign and redundant descriptions thereof are omitted.

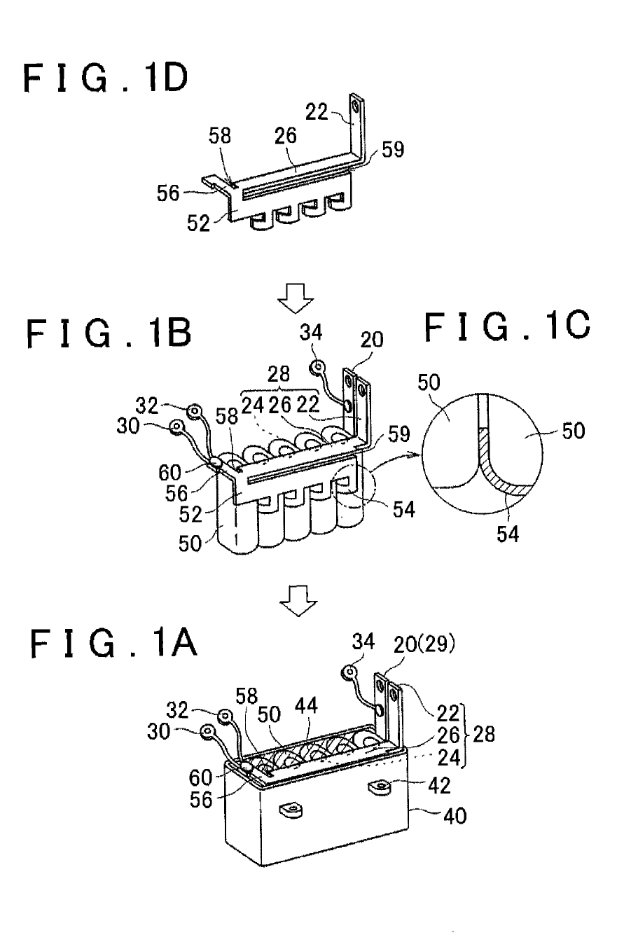

FIG. 1 is a view illustrating a structure of a capacitor module 10 connected to an inverter circuit to be provided in a hybrid vehicle. Here, the capacitor module 10 is destructured, so that its internal structure is shown. That is, FIG. 1A is a configuration diagram of the capacitor module 10, and illustrates a plurality of capacitor elements 50, a bus bar 28, etc accommodated in a mold case 40; FIG. 1B is a view illustrating a connection state of the plurality of capacitor elements 50 with respect to the bus bar 28, etc.; FIG. 1C is an expanded view of a tip portion 54 of a contact portion 52 that is integrated with the bus bar 28 and makes contact with the capacitor element 50; and FIG. 1D is a view illustrating the bus bar 28 including the contact portion 52 and an extending portion 56.

As illustrated in FIG. 1A, an outer shape of the capacitor module 10 is formed from the rectangular solid mold case 40, and attaching portions 42 provided in the mold case. From the mold case 40, a positive electrode portion 20 and a negative electrode portion 22 are drawn, and further, a temperature detection terminal 30, a negative-electrode voltage detection terminal 32, and a positive-electrode voltage detection terminal 34 are drawn.

The mold case 40 is a container made from a material having a heat dissipation characteristic and an electric insulation. As the mold case 40, it is possible to use a case obtained by molding a resin having appropriate heat resistance into a predetermined shape. As the material, ceramic may be used instead of the resin.

The positive electrode portion 20 and the negative electrode portion 22 are terminals respectively connected to a positive bus and a negative bus of the inverter circuit. The negative-electrode voltage detection terminal 32 and the positive-electrode voltage detection terminal 34 are terminals that detect a voltage between terminals of the capacitor module 10, that is, a system voltage, which is a voltage between the positive bus and the negative bus of the inverter circuit. Here, the positive-electrode voltage detection terminal 34 is drawn from the positive electrode portion 20. The temperature detection terminal 30 is a terminal that detects a temperature of the plurality of capacitor elements 50 constituting the capacitor module 10.

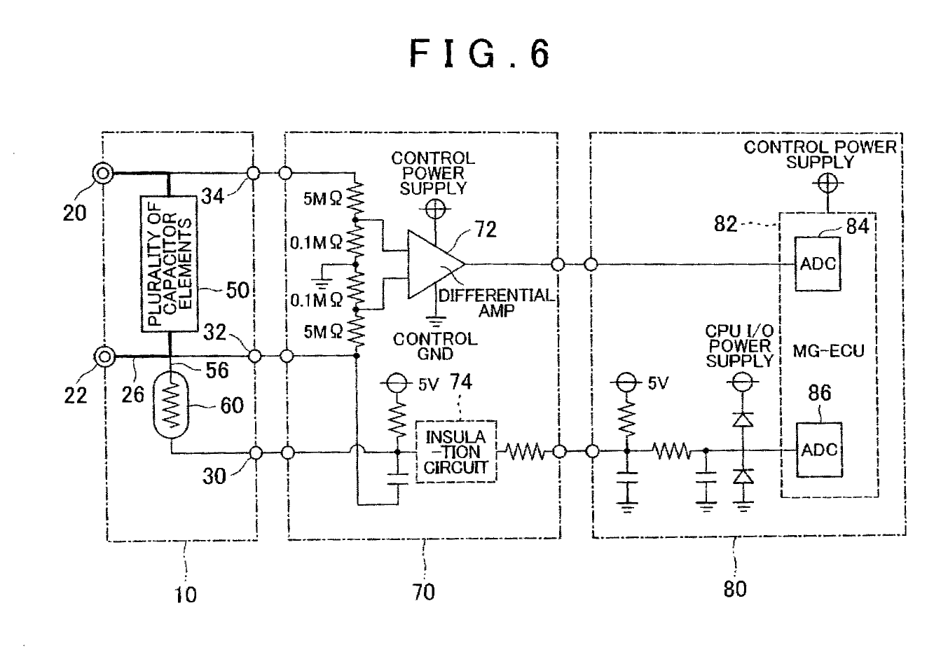

The temperature detection terminal 30, the negative-electrode voltage detection terminal 32, and the positive-electrode voltage detection terminal 34 are connected to a detecting circuit performing temperature detection and voltage detection. The detecting circuit performing temperature detection and voltage detection will be described later more specifically, with reference to FIG. 6.

The plurality of capacitor elements 50, the bus bar 28, etc., are accommodated in the mold case 40, and a molding resin 44 is filled therein.

The capacitor element 50 is a capacitance element having an appropriate capacity, withstand voltage characteristic, and heat resistance characteristic. As the capacitor element 50, it is possible to use a laminated-film capacitor obtained by winding a film-shaped positive plate and a film-shaped negative plate laminated via a dielectric separator.

Bus bars 28, 29 are electrical conduction materials that connect the plurality of capacitor elements 50 in parallel to each other. The bus bar 28 is an electrical conduction material that connects negative sides of the plurality of capacitor elements 50 to each other, and the bus bar 29 is electrical conduction materials that connect positive side of the plurality of capacitor elements 50 to each other. As the bus bars 28, 29, it is possible to use a bas bar obtained by machining a metal plate into a predetermined shape. For example, it is possible to use a bus bar obtained by machining a copper material, a copper alloy material, an aluminum material, a stainless steel material or the like into a predetermined shape.

The bus bar 28 is constituted by a bus bar body portion 26, an element connection portion 24, which is one end of the bus bar body portion 26 and is connected to negative terminal portions of the capacitor elements 50, and the negative electrode portion 22 for external connection, which is the other end of the bus bar body portion 26. The element connection portion 24 is connected to the negative terminal portions of the capacitor elements 50 by welding or the like. The negative electrode portion 22 is provided with a connecting hole through which a bolt or the like for connection to a connecting terminal of the inverter circuit passes.

Although not entirely illustrated in FIG. 1A, the bus bar 29 has the same configuration as the bus bar 28, and is constituted by a bus bar body portion, an element connection portion, which is one end of the bus bar body portion and is connected to positive terminal portions of the capacitor elements 50 by welding or the like, and the positive electrode portion 20, which is the other end of the bus bar body portion and is provided with a connecting hole for external connection. Note that only the positive electrode portion 20 is illustrated in FIG. 1A.

The bus bar 28 includes the extending portion 56 that extends in another direction separated from a path where a current flows in the bus bar 28. The path where a current flows in the bus bar 28 is a path which has a lowest electric resistance in the path and in which a current is easy to flow, in the bus bar 28 that connects the capacitor elements 50 to the negative electrode portion 22. In a case of FIGS. 1A, 1B, a path along the bus bar body portion 26 corresponds to the path where a current flows in the bus bar 28.

A thermistor 60 is a temperature sensor attached to the extending portion 56. As the temperature sensor, other temperature sensors may be used instead of the thermistor 60. For example, a temperature-detecting resistance element in which a relationship between a temperature and a resistance value is known may be used.

The thermistor 60 is attached to the extending portion 56 not to the bus bar body portion 26, which is the path where a current flows in the bus bar 28, so as not to be affected by a ripple current flowing between a positive electrode side and a negative electrode side of the plurality of capacitor elements 50. Since a ripple current flows through the bus bar body portion 26, its temperature increase is affected by the ripple current. It is the temperature in the plurality of capacitor elements 50 that the thermistor 60 intends to detect. However, a temperature of the bus bar body portion 26 does not necessarily precisely indicate the temperature in the plurality of capacitor elements 50 because of the following reason.

That is, a frequency component of the ripple current changes according to an operating state of the inverter circuit. Further, since frequency characteristics of the plurality of capacitor elements 50 are also different from each other, when the ripple current state changes, a capacitor element that receives the ripple current is replaced to another, thereby resulting in that a capacitor element of which a temperature increase becomes maximum due to discharge and charge of the ripple current will be changed after all. The temperature of the bus bar body portion 26 indicates a temperature to increase due to a resistance drop of the ripple current itself, but does not precisely indicate the temperature of the capacitor elements 50 in which a heat resistance becomes a problem. For this reason, the thermistor 60 is attached to the extending portion 56 not to the bus bar body portion 26.

The molding resin 44 is filled into the mold case 40 so that the molding resin 44 adheres to the plurality of capacitor elements 50 so as to improve a heat dissipation characteristic. As the molding resin 44, it is possible to use a resin having an appropriate heat resistance. For example, it is possible to use epoxy resin. The molding resin 44 is filled so as to cover the plurality of capacitor elements 50. As for the bus bar 28, the bus bar body portion 26 and the extending portion 56 may be covered with the molding resin 44, but the thermistor 60 is not covered therewith.

If the thermistor 60 is covered with the molding resin 44, the molding resin 44 receives heat generated from the plurality of capacitor elements 50, so that its temperature increase considerably, which affects a temperature characteristic of the thermistor 60. On this account, the thermistor 60 is not covered with the molding resin 44, and is exposed from the molding resin 44.

FIG. 1B is a view illustrating a connection state of the plurality of capacitor elements 50 with respect to the bus bar 28, etc., before being accommodated in the mold case 40. Although not illustrated in FIG. 1B due to being hidden behind the mold case 40, the bus bar 28 includes the contact portion 52 making contact with the plurality of capacitor elements 50, in addition to the extending portion 56. The extending portion 56 does not extend from the bus bar body portion 26 directly, but extends from the contact portion 52.

That is, the contact portion 52 is integrated with the bus bar 28 and makes contact with heat generation portions of the capacitor elements 50. The contact portion 52 may be integrated with the bus bar 28 in such a manner that a single material is machined to form the bus bar 28 and the contact portion 52 as a single component, or the bus bar 28 and the contact portion 52 are formed as separate components and are integrated with each other by a connecting member having a good heat transfer characteristic. In the latter case, the contact portion 52 may be made from a nonconductive material. In the following description, the bus bar 28 and the contact portion 52 are made from the same material so as to be integrated with each other.

The thermistor 60 is attached to the extending portion 56 extending, toward a direction different from the path where the current flows, from the contact portion 52 making contact with the heat generation portions. This allows the thermistor 60 to accurately detect a temperature of the heat generation portions of the plurality of capacitor elements 50, without being affected by a ripple current flowing through the bus bar body portion 26, and current variations.

The contact portion 52 is a plate portion made from a conductive material integrated with the bus bar body portion 26 and provided so as to make contact with outer circumferences of the plurality of capacitor elements 50. As described in FIG. 1A, the plurality of capacitor elements 50, the bus bar 28, etc., are accommodated in the mold case 40, and the molding resin is filled therein. Accordingly, since gaps between the contact portion 52 and the outer circumferences of the plurality of capacitor elements 50 are filled with the molding resin 44 for heat dissipation, heat generated from the plurality of capacitor elements 50 is efficiently transferred to the contact portion 52.

The tip portion 54 of the contact portion 52 has a shape along the outer circumference of the cylindrical capacitor element 50. As illustrated in an expanded sectional view of FIG. 1D, the tip portion 54 of the contact portion 52 is inserted into a gap between the capacitor elements 50 adjacent to each other. It is considered that, in the plurality of capacitor elements 50, the gap between the capacitor elements 50 adjacent to each other is easy to be hot and a temperature therebetween becomes highest. By inserting the tip portion 54 of the contact portion 52 into the gap, heat generated from the plurality of capacitor elements 50 is efficiently transferred to the contact portion 52, and thereby further improving detection accuracy of the thermistor 60.

A notch portion 58 is a portion (space) which is provided between the extending portion 56 and the path along the bus bar body portion 26 (i.e., the path where a current flows in the bus bar 28) and which is cut out so that the bus bar body portion 26 is connected to the extending portion 56 via a thin connection portion. Hereby, a connection between the bus bar body portion 26 and the extending portion 56 becomes highly resistive in terms of electric resistance and heat resistance. A notch portion 59 is a portion (space) which is provided between the contact portion 52 and the path along the bus bar body portion 26 (the path where a current flows in the bus bar 28) and which is cut out so that the bus bar body portion 26 is connected to the contact portion 52 via a thin connection portion. Hereby, a connection between the bus bar body portion 26 and the contact portion 52 becomes highly resistive in terms of electric resistance and heat resistance.

When the notch portions 58, 59 are provided, the path along the bus bar body portion 26 serves as a path which has a lowest electric resistance and in which a current is easy to flow, in the bus bar 28 including the contact portion 52 and the extending portion 56. This allows the thermistor 60 provided in the extending portion 56 to accurately detect the temperature of the heat generation portions of the plurality of capacitor elements 50 via the contact portion 52, without being affected by a ripple current flowing through the bus bar body portion 26, and current variations.

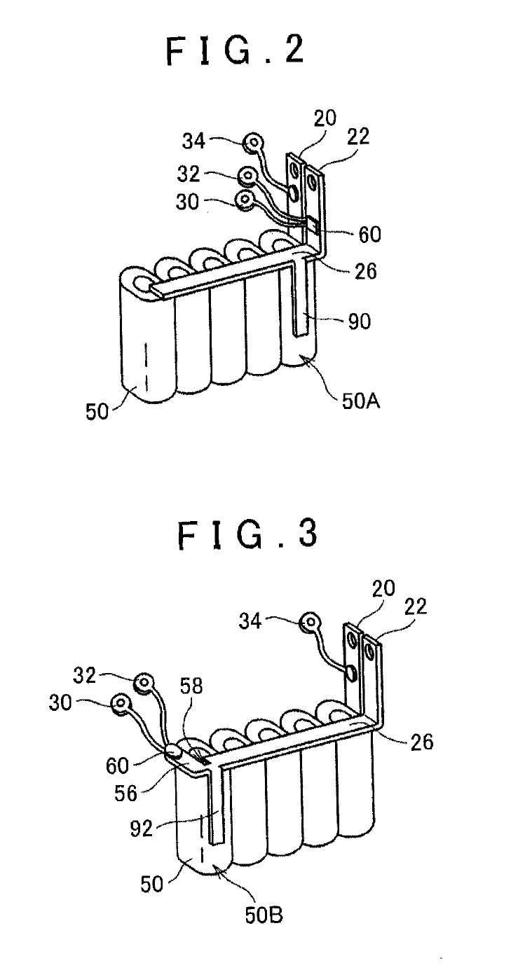

FIGS. 2 to 5 are views illustrating examples of other contact portions. FIGS. 2 and 3 are views illustrating an example in which in a case where a capacitor element 50A, 50B causing maximum heat generation has been known in advance, a contact portion 90, 92 is provided on an outer circumference of the capacitor element 50A, 50B so as to be integrated with a bus bar body portion 26.

FIG. 2 is a reference example in which in a case where the capacitor element 50A placed on the rightmost side in a plane of paper causes maximum heat generation, the contact portion 90 is provided so as to make contact with the outer circumference of the capacitor element 50A. In this case, if a thermistor 60 is provided in an extending portion 56 on the leftmost side in a plane of paper like FIG. 1, a maximum heat generation portion is too distanced from the thermistor 60. In view of this, the thermistor 60 is attached on a negative electrode portion 22. Even in this case, the thermistor 60 is not attached to the bus bar body portion 26, which is the path where a current flows in a bus bar 28.

In FIG. 3, in a case where the capacitor element 50B placed on the leftmost side in a plane of paper causes maximum heat generation, the contact portion 92 is provided so as to make contact with the outer circumference of the capacitor element 508. In this case, similarly to FIG. 1, a thermistor 60 is attached on an extending portion 56. A notch portion 58 is provided between the bus bar body portion 26 and the extending portion 56, similarly to FIG. 1. In comparison with FIG. 1, the contact portion 92 has a small area, thereby making it possible to reduce a cost of a bus bar as a whole.

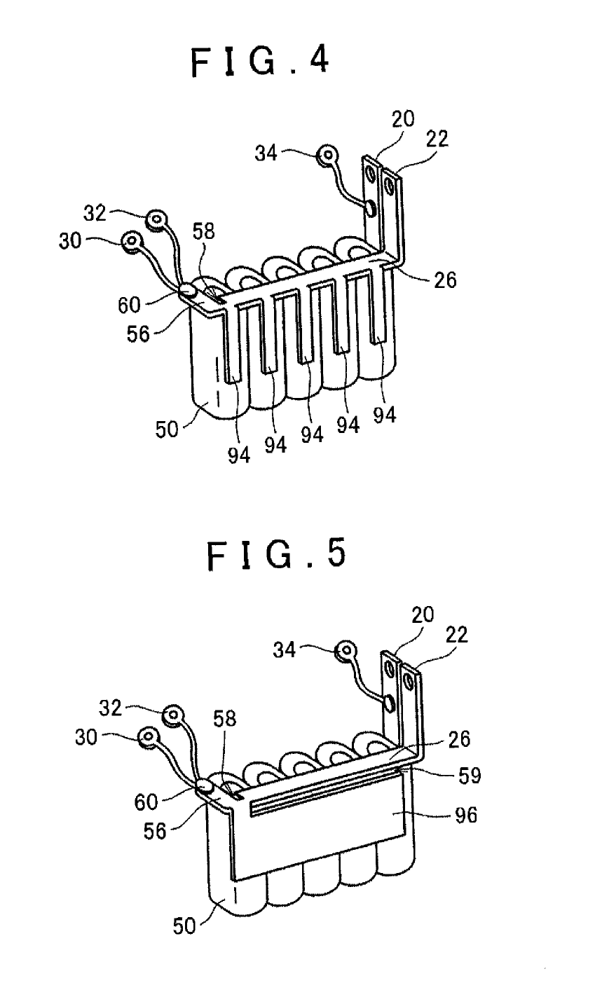

FIGS. 4, 5 are views illustrating a configuration of a heat dissipation portion that accurately detects a maximum temperature in a plurality of capacitor elements 50 in a case where it is not known which capacitor element causes maximum heat generation. In FIG. 4, separate contact portions 94 are provided on respective outer circumferences of all the capacitor elements 50. A notch portion 58 is provided between a bus bar body portion 26 and an extending portion 56, similarly to FIG. 1. In comparison with FIG. 1, the contact portion 94 has a small area, thereby making it possible to reduce a cost of a bus bar as a whole.

In FIG. 5, a contact portion 96 that does not have any tip portion 54 unlike FIG. 1 is used. A notch portion 58 is provided between a bus bar body portion 26 and an extending portion 56, similarly to FIG. 1, and a notch portion 59 is provided between the bus bar body portion 26 and the extending portion 56, similarly to FIG. 1. Since the tip portions 54 are not provided, it is possible to easily perform machining of a whole bus bar.

FIG. 6 is a view illustrating a configuration of a detecting circuit 70 connected to the capacitor module 10 and performing temperature detection and voltage detection, and a connection relationship between the detecting circuit 70 and an inverter control circuit 80. FIG. 6 illustrates, as the capacitor module 10, the positive electrode portion 20, the negative electrode portion 22, the bus bar body portion 26 on a negative side, the extending portion 56, the thermistor 60, the temperature detection terminal 30, the negative-electrode voltage detection terminal 32, and the positive-electrode voltage detection terminal 34, which are connected to the plurality of capacitor elements 50.

As illustrated in FIG. 6, one of two terminals of the thermistor 60 is the temperature detection terminal 30 used only for temperature detection, but the other one of the two terminals is used for temperature detection and negative electrode voltage detection. As such, the thermistor 60 is provided on the extending portion 56 integrated with the bus bar 28, and the other terminal of the thermistor 60 is connected to the extending portion 56, which allows the other terminal to be used for temperature detection and negative electrode voltage detection. This makes it possible to reduce one terminal of the capacitor module 10.

The detecting circuit 70 has a voltage detection function (a voltage detecting circuit) to input detection values of the negative-electrode voltage detection terminal 32 and the positive-electrode voltage detection terminal 34 into two input terminals of a differential amplifier 72, and to output a voltage between terminals of the capacitor module 10 with respect to a control GND. Further, the detecting circuit 70 has a temperature detection function (a temperature detecting circuit) to output a voltage value corresponding to a temperature via a protective circuit 74 based on detection values of respective terminals of the thermistor 60.

The voltage between terminals of the capacitor module 10 which voltage is output from the detecting circuit 70 is converted into a digital system voltage value by an ADC 84 provided in an MG-ECU 82 serving as a controller of the inverter control circuit 80. Further, the voltage value corresponding to the temperature which voltage value is output from the detecting circuit 70 is subjected to suitable level conversion, and then converted into a digital temperature value by another ADC 86 provided in the MG-ECU 82. With the use of these pieces of data thus subjected to digital conversion, the MG-ECU 82 controls an operation of the inverter circuit, and controls an operation of a rotating electrical machine provided in a vehicle and connected to the inverter circuit.

As such, in the capacitor module 10, a shape of the bus bar 28 connected to the plurality of capacitor elements 50 is devised such that the bus bar 28 includes the contact portion 52 making contact with the heat generation portions of the capacitor elements 50, and the extending portion 56 extending from the contact portion 52 in a direction different from the path where a current flows in the bus bar 28. Further, the thermistor serving as a temperature sensor is attached to the extending portion 56, thereby making it possible to accurately and precisely detect the temperature of the plurality of capacitor elements 50. This makes it possible to protect the capacitor module 10, and to improve accuracy of controls on an inverter circuit and a rotating electrical machine to be provided in a vehicle.

What is claimed is:

1. A capacitor module comprising:
a plurality of capacitor elements;
a bus bar including an element connection portion on one end of the bus bar and an electrode portion for external connection on the other end of the bus bar, the element connection portion being electrically connected to respective terminal portions of the plurality of capacitor elements;
a contact portion connected to the bus bar and making contact with heat generation portions of the plurality of capacitor elements; and
a temperature sensor disposed on an extending portion extending from the contact portion.

2. The capacitor module according to claim 1, wherein:
the extending portion defines a path different from a path where a current flows.

3. The capacitor module according to claim 1, wherein:
the capacitor module has a gap between the extending portion and a path where a current flows in the bus bar.

4. The capacitor module according to claim 1, wherein:
the contact portion is placed between the capacitor elements adjacent to each other.

5. The capacitor module according to claim 1, further comprising:
a case accommodating therein the plurality of capacitor elements connected via the bus bar; and
a molding resin disposed in the case to mold the plurality of capacitor elements, wherein:
the temperature sensor is not covered with the molding resin.

6. A detecting apparatus comprising:
the capacitor module according to claim 1; and
a detecting circuit including a temperature detecting circuit detecting a temperature, and a voltage detecting circuit detecting a voltage between a negative terminal of the capacitor module and a positive terminal of the capacitor module, the temperature detecting circuit electrically connected to one terminal and the other terminal of the temperature sensor, and the voltage detecting circuit electrically connected to the other terminal of the temperature sensor.
